(19) United States
(12) Patent Application Publication
(10) Pub. No.: US 2026/0145680 A1
(43) Pub. Date: May 28, 2026

(54) Device and Method for Operating a Driving Function on an Approach Roadway to a Signaling Unit

(71) Applicant: Bayerische Motoren Werke Aktiengesellschaft, Muenchen (DE)

(72) Inventors: Uwe MOSER, Muenchen (DE); Felix REMPE, Dachau (DE)

(21) Appl. No.: 19/121,167

(22) PCT Filed: Sep. 15, 2023
(86) PCT No.: PCT/EP2023/075489

§ 371 Date: Apr. 15, 2025

(30) Foreign Application Priority Data
Oct. 17, 2022 (DE) 10 2022 127 111.0

(51) Int. Cl. B60W 30/18; B60W 50/14; B60W 60/00

(52) U.S. Cl. CPC B60W 30/18163; B60W 30/18154; B60W 50/14; B60W 60/001; B60W 2050/146; B60W 2540/215; B60W 2552/10; B60W 2556/40

(57) ABSTRACT

A device for operating a driving function for automated longitudinal and/or lateral control of a vehicle on an approach roadway to a signalling unit is described. The device is designed to determine a first assignment of a signalling element of the signalling unit to a first lane of the approach roadway, in which first lane the vehicle is driving. The device is also designed to determine a first confidence value for the confidence of the first assignment and, according to the first confidence value, to initiate a lane change of the vehicle to an adjacent second lane of the approach roadway.

### BACKGROUND AND SUMMARY

The invention relates to a device and a corresponding method for controlling an approach procedure of a motor vehicle to a signaling unit.

A vehicle can have one or more driving functions which assist the driver of the vehicle in the guidance, in particular in the longitudinal guidance and/or in the lateral guidance, of the vehicle. One exemplary driving function for assisting the longitudinal guidance of a vehicle is the adaptive cruise control (ACC) function, which can be used to longitudinally guide the vehicle at a defined set driving speed and/or at a defined desired distance from a preceding vehicle driving in front of the vehicle. The driving function can also be used here in conjunction with a signaling unit (in particular with a traffic signal) at a traffic node point (for example, at an intersection), in order to effectuate automated longitudinal guidance, such as an automated deceleration or an automated turning maneuver, at the traffic signal generator.

The approach to a signaling unit at a traffic node point can have different lanes for different travel directions at the traffic node point. Furthermore, the signaling unit can have different signal generators, which can be assigned at least partially to different lanes and/or different travel directions.

The present document deals with the technical problem of increasing the quality of a driving function for automated longitudinal and/or lateral guidance of a vehicle at a signaling unit which has different signal generators for different lanes and/or travel directions.

The object is achieved by each individual one of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

According to one aspect, a device for operating a driving function for automated longitudinal and/or lateral guidance of a (motor) vehicle on a (multilane) approach roadway to a signaling unit (in particular to a traffic signal system) is described. The signaling unit can be arranged at a traffic node point, in particular at an intersection. The signaling unit can have different signal generators (for example, traffic signals), which are assigned to different lanes and/or travel directions (for example, for turning to the left, for driving straight ahead, or for turning to the right).

The driving function can be designed to longitudinally and/or laterally guide the vehicle in an automated manner depending on the signaling status of a signal generator of the signaling unit. The vehicle can be caused to come to a stop automatically at a stopping line of the signaling unit here, for example, if the signal generator (which is relevant for the lane and/or for the travel direction) is red. On the other hand, the vehicle can be caused to be longitudinally and/or laterally guided past the signaling unit in an automated manner if the signal generator (which is relevant for the lane and/or for the travel direction) is green.

The signal generator relevant for the lane and/or the travel direction of the vehicle can be indicated by an assignment, wherein the assignment identifies the one or more signal generators of the signaling unit which are assigned to the respective lane and/or travel direction (and which are relevant for a journey on the respective lane and/or for a journey in the respective travel direction). Multiple different assignments can exist for a roadway having multiple lanes and/or for a signaling unit having multiple signal generators. The assignments can have been determined beforehand on the basis of data which were acquired in the scope of preceding journeys on the approach roadway. The assignments can be provided in a digital map for the roadway network traveled by the vehicle (for example, as a map attribute).

A confidence value for the confidence of the assignment can have been ascertained for each of the individual assignments. The confidence of an assignment can indicate the probability that the assignment is correct. The confidence values can have been ascertained on the basis of the data from the preceding journeys. The confidence values can be scaled to a defined value range (for example, between 0 for 0% confidence and 1 for 100% confidence).

A digital map can therefore be provided which, for each of different lanes of the approach roadway, indicates an assignment of at least one signal generator of the signaling unit to the respective lane and a confidence value for the respective assignment. The digital map can be received by the vehicle via a wireless communication connection.

The device is configured to ascertain a first assignment of a signal generator of the signaling unit to the first lane of the approach roadway traveled by the vehicle. The device is furthermore configured to ascertain a first confidence value for the confidence of the first assignment. The first confidence value for the confidence of the first assignment can be ascertained, for example, on the basis of the digital map for the roadway network traveled by the vehicle. The first assignment can be ascertained on the basis of the digital map and/or on the basis of sensor data from one or more surroundings sensors (e.g. a camera, a radar sensor, a lidar sensor, etc.) of the vehicle.

The device is furthermore configured to prompt a lane change of the vehicle to an adjacent second lane of the approach roadway depending on the first confidence value. A second lane can be selected here which is associated with the same travel direction at the signaling unit as the first lane. An automated lane change of the vehicle to the second lane of the approach roadway can optionally be effectuated (in the scope of the driving function). Alternatively, the driver of the vehicle can be prompted by outputting a notification to carry out the lane change of the vehicle to the second lane of the approach roadway manually.

The device can furthermore be configured (for example, on the basis of sensor data of the one or more surroundings sensors of the vehicle) to ascertain the signaling status of the signal generator of the signaling unit, which is assigned to the lane traveled by the vehicle (in particular the first lane or the second lane). The driving function for automated longitudinal and/or lateral guidance of the vehicle can be operated depending on the ascertained signaling status (for example, to automatically decelerate the vehicle at the signaling unit or to guide the vehicle in an automated manner past the signaling unit).

By carrying out a lane change to another lane, the comfort and/or the safety of the driving function during an approach procedure to the signaling unit can be increased in an efficient and reliable manner (in particular if an increased level of confidence with respect to the signal generator-lane assignment exists for the second lane).

The device can be configured to ascertain the planned travel direction of the vehicle at the signaling unit. The travel direction can be ascertained on the basis of a driving route for the vehicle planned in a navigation system and/or on the basis of the travel direction associated with the first lane. A set of lanes of the approach roadway for the planned travel direction of the vehicle at the signaling unit can then be ascertained (for example, on the basis of the digital map for the roadway network traveled by the vehicle), wherein the ascertained set of lanes typically comprises the first lane. In other words, the one or more lanes of the approach roadway can be ascertained which enable the ascertained travel direction of the vehicle at the signaling unit. The second lane can then be selected from the ascertained set of lanes. The quality of the driving function can thus be further increased.

The device can be configured to ascertain a second assignment of a signal generator of the signaling unit to the adjacent second lane of the approach roadway, and to ascertain a second confidence value for the confidence of the second assignment (for example, on the basis of the digital map).

The first confidence value can be compared with the second confidence value, and a lane change of the vehicle to the second lane of the approach roadway can be prompted depending on the comparison. The device can be configured in particular here to prompt the lane change of the vehicle to the second lane if it is ascertained in the context of the comparison of the confidence values that the confidence of the second assignment is higher than the confidence of the first assignment. On the other hand, the device can be configured not to prompt the lane change of the vehicle to the second lane (and to leave the vehicle on the first lane) if it is ascertained in the context of the comparison of the confidence values that the confidence of the first assignment is higher than the confidence of the second assignment. The quality of the driving function can thus be further increased.

The device can be configured to output assignment information with respect to the first assignment to the driver of the vehicle, in particular if the first confidence value indicates that the confidence of the first assignment is less than a confidence threshold value. If a relatively uncertain first assignment exists, a query to the driver can thus be effectuated to obtain a confirmation or an adaptation of the first assignment by the driver. The first assignment can be adapted in reaction to a user input, and the driving function can thereupon be operated using the adapted assignment. The quality of the driving function can thus be further increased.

According to a further aspect, a further device for operating a driving function for automated longitudinal and/or lateral guidance of a (motor) vehicle on an approach roadway to a signaling unit is described. The measures described in this document are also applicable individually and in combination to this device.

The device is configured to ascertain an assignment of a signal generator of the signaling unit to a lane of the approach roadway traveled by the vehicle and/or to a planned travel direction of the vehicle at the signaling unit (for example, on the basis of the digital map).

The device is furthermore configured to output assignment information with respect to the ascertained assignment to the driver of the vehicle (for example, to display it on a display screen of the vehicle). In this context, a confidence value for the confidence of the assignment can be ascertained (for example, on the basis of the digital map). The assignment information with respect to the ascertained assignment can be output to the driver of the vehicle (possibly only then) if the confidence value indicates that the confidence of the assignment is less than the confidence threshold value. On the other hand, the output of the assignment information can possibly be suppressed if the confidence value indicates that the confidence of the assignment is greater than the confidence threshold value.

In addition, the device is configured to adapt the assignment in reaction to a user input (of the driver), and thereupon to operate the driving function depending on the adapted assignment.

The device can be configured, for example, to acquire a user input (via a user interface of the vehicle), and to determine whether the assignment indicated by the assignment information is confirmed or adapted by the user input. The driving function can then be operated depending on the assignment indicated by the assignment information if this is confirmed by the user input. On the other hand, the driving function can be operated depending on the adapted assignment if the assignment indicated by the assignment information is adapted by the user input.

Therefore, in particular if a relatively low confidence exists, an involvement of the driver can be effectuated in order to confirm or adapt the assignment (indicated by the digital map). The quality of the driving function can thus be increased in a particularly efficient and reliable manner.

The device can be configured to abort the operation of the driving function and/or prompt a transfer to the driver of the vehicle if no user input for adaptation and/or for confirmation of the assignment is detected in reaction to the output of the assignment information within a predefined period of time. The safety of the driving function can thus be further increased.

The device can be configured to output an optical representation (for example, on a touch-sensitive display screen), which indicates multiple different signal generators of the signaling unit, which can be assigned to the lane of the approach roadway traveled by the vehicle and/or to the planned travel direction of the vehicle at the signaling unit. In the optical representation, the signal generator from the ascertained assignment can be visually highlighted here.

A user input with respect to a selection of one of the displayed signal generators by the driver can then be ascertained. For example, it can be made possible for the driver to touch the symbol of a signal generator in the optical representation in order to select this signal generator. The assignment (used by the driving function) can then be adapted in a particularly efficient and reliable manner based on the selected signal generator.

According to a further aspect, a (road) motor vehicle (in particular a passenger vehicle or a truck or a bus or a motorcycle) is described which comprises one or more of the devices described in this document.

According to a further aspect, a method for operating a driving function for automated longitudinal and/or lateral guidance of a (motor) vehicle on a (multilane) approach roadway to a signaling unit is described. The method comprises ascertaining a first assignment of a signal generator of the signaling unit to a first lane of the approach roadway traveled by the vehicle. Furthermore, the method comprises ascertaining a first confidence value for the confidence of the first assignment. The method furthermore comprises prompting, depending on the first confidence value, a lane change of the vehicle to an adjacent second lane of the approach roadway.

According to a further aspect, a method for operating a driving function for automated longitudinal and/or lateral guidance of a (motor) vehicle on an approach roadway to a signaling unit is described. The method comprises ascertaining an assignment of a signal generator of the signaling unit to the lane of the approach roadway traveled by the vehicle and/or to the planned travel direction of the vehicle at the signaling unit. The method furthermore comprises outputting assignment information with respect to the ascertained assignment to a driver of the vehicle. In addition, the method comprises adapting the assignment in reaction to a user input, and operating the driving function depending on the adapted assignment.

According to a further aspect, a software (SW) program is described. The SW program can be configured to be executed on a processor (for example, on a control unit of a vehicle), and to thus carry out one or more of the methods described in this document.

According to a further aspect, a storage medium is described. The storage medium can comprise an SW program, which is configured to be executed on a processor, and to thus carry out one or more of the methods described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments.

### BRIEF DESCRIPTION OF THE DRAWINGS

FIG. 1 shows exemplary components of a vehicle;

FIG. 2a shows an exemplary signaling unit, in particular a traffic signal system;

FIG. 2b shows an exemplary approach to a traffic node point;

FIG. 2c shows an exemplary visual output of the travel direction/lane-signal generator assignment;

FIG. 3 shows an exemplary traffic situation;

FIG. 4a shows a flow chart of an exemplary method for operating a vehicle when approaching a signaling unit; and

FIG. 4b shows a flow chart of an exemplary method for adapting a travel direction/lane-signal generator assignment in the context of an approach procedure to a signaling unit.

### DETAILED DESCRIPTION OF THE DRAWINGS

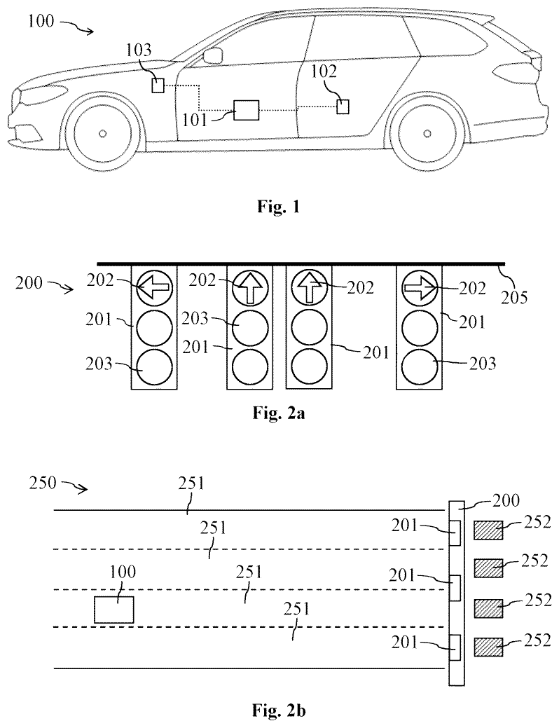

As described at the outset, the present document relates to effectuating particularly reliable operation of a vehicle during the approach to a signaling unit. In this context, FIG. 1 shows exemplary components of a vehicle 100. The vehicle 100 comprises one or more surroundings sensors 103 (e.g. one or more image cameras, one or more radar sensors, one or more lidar sensors, one or more ultrasonic sensors, etc.), which are each configured to acquire surroundings data with respect to the surroundings of the vehicle 100 (in particular with respect to the surroundings in the travel direction in front of the vehicle 100). Furthermore, the vehicle 100 comprises one or more actuators 102, which are configured to act on the longitudinal and/or lateral guidance of the vehicle 100. Exemplary actuators 102 are: a braking system, a drive motor, a steering system, etc.

The (control) device 101 of the vehicle 100 can be configured to provide a driving function, in particular a driver assistance function, on the basis of the sensor data of the one or more surroundings sensors 103 (i.e. on the basis of the surroundings data). For example, an obstacle on the driving trajectory of the vehicle 100 can be detected on the basis of the sensor data. The control unit 101 can thereupon actuate one or more actuators 102 (for example, the braking system), in order to decelerate the vehicle 100 in an automated manner and to thus prevent a collision of the vehicle 100 with the obstacle.

In particular in the context of the automated longitudinal guidance of a vehicle 100, alternatively or additionally to a preceding vehicle, one or more traffic signal systems on the roadway or road traveled by the vehicle 100 can be taken into consideration. In particular the status of a traffic signal system can be taken into consideration here, so that the vehicle 100 automatically causes a deceleration up to the stopping line of the traffic signal at a red traffic signal relevant for the individual (planned) travel direction and/or accelerates (possibly again) at a green traffic signal.

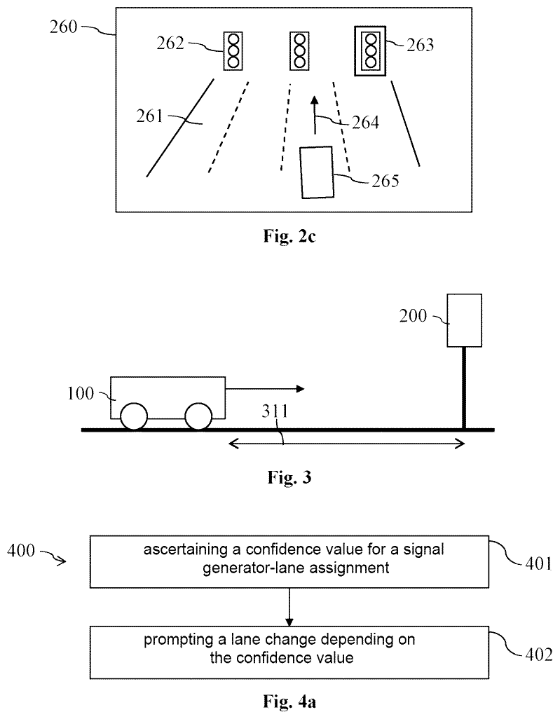

FIG. 2a shows an exemplary traffic signal system 200 (as an example of a signaling unit). The traffic signal system 200 shown in FIG. 2a has four different signal generators 201, which are arranged at different positions at an approach to an intersection. The left signal generator 201 has an arrow 202 to the left, and therefore indicates that this signal generator 201 applies for turning to the left. The two middle signal generators 201 have an arrow 202 upward (or no arrow 202) and therefore indicate that these two signal generators 201 apply for driving straight ahead. The individual light characters 203 of these two signal generators 201 form signal groups. Furthermore, the right signal generator 201 has an arrow 202 to the right, and therefore indicates that this signal generator 201 applies for turning to the right.

The approach roadway 250 to an intersection can have multiple lanes 251, as shown by way of example in FIG. 2b. The different signal generators 201 of the signaling unit 200 can be assigned to different lanes 251. In the example shown in FIG. 2b, for example, the signal generator 201 for turning to the left can be assigned to the left lane 251. Furthermore, the one or more signal generators 201 for driving straight ahead can be assigned to the two middle lanes 251. Furthermore, the signal generator 201 for turning to the right can be assigned to the right lane 251 (and possibly also the lane 251 on the right of the two middle lanes 251).

The assignment between the individual signal generators 201 and the different lanes 251 of a roadway 250 can be stored in a digital map for the roadway network traveled by the vehicle 100. The assignment can have been created here on the basis of data which were provided by vehicles 100 on the basis of a large number of journeys over the intersection. An assignment created on the basis of such vehicle data can possibly be flawed.

In the context of the ascertainment of the assignment between signal generators 201 and lanes 251, a confidence value 252 can have been ascertained for each of the individual lanes 251 of the roadway 250, which indicates the confidence (for example, the probability) that the signal generator 201 indicated by the assignment for the respective lane 251 is correct. The confidence values 252 of the signal generator-lane assignments can be taken into consideration in the context of the operation of a driving function of a vehicle 100. The quality of the driving function can thus be increased.

FIG. 3 shows by way of example a vehicle 100, which approaches a signaling unit 200 on a roadway. The one or more surroundings sensors 103 of the vehicle 100 can be configured to acquire sensor data (in particular image data) with respect to the signaling unit 200. The sensor data can be analyzed (for example, by means of an image analysis algorithm), to ascertain characteristics of one or more features of the signaling unit 200. In particular, the (signaling) status of one or more signal generators 201 of the signaling unit 200 (for example, the color, such as red, yellow, or green) can be ascertained on the basis of the sensor data. In addition, the distance 311 of the signaling unit 200 from the vehicle 100 can be ascertained.

The device 101 of the vehicle 100 can be configured, in the context of an approach procedure to a signaling unit 200, to ascertain the lane 251 from a plurality of different lanes 251 of the roadway 250 on which the vehicle 100 is located. This can be ascertained on the basis of the surroundings data of the one or more surroundings sensors 103 of the vehicle 100. The device 101 can furthermore be configured to identify the signaling unit 200 and/or the individual signal generators 201 of the signaling unit 200, for example on the basis of the surroundings data.

Furthermore, the device 101 can be configured to ascertain, on the basis of the digital map, the different signal generator-lane assignments for the identified signaling unit 200. The signal generator 201, which is relevant for the lane 251 on which the vehicle 100 is located, can then be identified based on the signal generator-lane assignments. Furthermore, the confidence value 252 for this signal generator-lane assignment can be ascertained.

If the confidence value 252 of the assignment is relatively high, for example higher than a predefined confidence threshold value, the driving function can be operated in consideration of the assignment. For this purpose, the signaling status of the identified signal generator 201 can be ascertained (on the basis of the surroundings data). Furthermore, the automated longitudinal and/or lateral guidance of the vehicle 100 can be effectuated depending on the signaling status of the identified signal generator 201 (for example, to automatically decelerate the vehicle 100 when the color of the signal generator 201 is red).

The device 101 can be configured to ascertain (for example, on the basis of the digital map) whether the roadway 250 has a further lane 251 in addition to the currently traveled lane 251 for the planned travel direction of the vehicle 100 at the upcoming traffic node point. For example, it can be ascertained that the roadway 250 also has a further, directly adjacent lane 251 for driving straight ahead in addition to the currently traveled lane 251. A set of lanes 251 of the roadway 250 can therefore be ascertained which can be used for the planned travel direction of the vehicle 100. Furthermore, the confidence values 252 of the signal generator-lane assignments for the individual lanes 251 can be ascertained from the set of lanes 251. The lane 251 can then be identified on the basis of the confidence values from the set of lanes 251 for which the highest confidence exists with respect to the correctness of the assigned signal generator 201.

Furthermore, the device 101 can prompt (for example, by outputting a notification to the driver and/or by actuating the one or more actuators 102) the vehicle 100 to change from the currently traveled lane 251 to the identified lane 251 in the context of the approach procedure to the signaling unit 200. The automated approach procedure of the vehicle 100 can then be carried out on the identified lane 251. The quality of the driving function can thus be further increased.

The device 101 of the vehicle 100 can be designed to output assignment information with respect to the assignment ascertained and/or used by the vehicle 100 between the currently traveled lane 251 or the travel direction planned by the vehicle 100 and a signal generator 201 of the signaling unit 200 to the driver of the vehicle 100. The assignment information can be output via a user interface of the vehicle 100, in particular displayed on a (touch-sensitive) display screen of the vehicle 100.

FIG. 2c shows an exemplary visual representation 260 of the assignment information for the driving situation shown in FIG. 2b. The visual representation 260 can comprise, for example, a representation 261 of the individual lanes 251 and a representation 262 of the individual signal generators 201. Furthermore, a representation 265 of the vehicle 100 can be displayed. The lane 251 on which the vehicle 100 is currently driving can also be displayed here. Furthermore, the planned travel direction 264 of the vehicle 100 can be displayed.

The visual representation 260 can furthermore display the one or more signal generators 201 which were assigned to the current lane 251 and/or the planned travel direction 264. This can be represented, for example, by a visual highlighting 263 of the one or more signal generators 201.

It can be made possible for the driver of the vehicle 100 to adapt the assignment used by the vehicle 100. In particular, it can be made possible for the driver to select the one or more signal generators 201 which are to be used by the driving function of the vehicle 100. For example, it can be made possible for the driver to touch the symbol 262 of a signal generator 201 in the visual representation 260 in order to select this signal generator 201. The assignment used by the driving function can then be adapted according to the selected signal generator 201. The signaling status of the selected signal generator 201 can thereupon be used during the operation of the driving function of the vehicle 100. The quality of the driving function can thus be further increased.

Therefore, in addition to the sensor information from a vehicle 100, data from a fleet of vehicles can be used, which have in the past already completed (in the manual or automated driving mode) the driving relationship to be assessed currently. The data of the vehicle fleet, e.g. GPS data, timestamps, roadway and lane identifiers, travel direction, image data, radar data, lidar data, etc., can be collected on a central server, evaluated, and sent to the vehicle 100.

On the basis of one or more confidence values 252 and/or by a comparison with current sensor information (of the one or more surroundings sensors 103 of the vehicle 100), the vehicle 100 can decide whether the assignment of the traffic signal (i.e. the signal generator 201) to the lane 251 and the stopping line is correct and the vehicle 100 can drive in an automated manner or whether the driver has to take over the driving operation. Each lane 251 or each driving relationship can have a different confidence value 252 here. A lane change can be proposed to the driver here or a lane change to a lane 251 having a higher confidence can be carried out in an automated manner.

The confidence values 252 for the assignment of driving relationships or lanes 251 to traffic signal systems and/or stopping lines can be continuously improved by an automatic method and/or by a method with involvement of the driver. If the situation changes due to structural measures etc., for example, the confidence value 252 for an assignment can possibly be reduced.

Driving over intersections having traffic signal systems 200 can be carried out with an increased level of safety by way of the described measures. Furthermore, the frequency with which such driving is carried out in an automated manner without interruption can be increased.

In one example, a driver approaches an intersection in an automated vehicle 100, for example SAE level 2 (hands-off) or SAE level 3 (eyes-off), etc., in the automated mode. There are three lanes 251 on the road 250, one left turn lane, one straight ahead lane, and one divided straight ahead+right turn lane. It is identified by the vehicle 100 by way of the sensor system 103 in the vehicle 100 and by the geolocation on which lane 251 (for example, the rightmost lane) the vehicle 100 is driving. In addition, it is identified that there are 5 traffic signals 201. It is known from a planned driving route in the navigation system of the vehicle 100 that the driver wishes to turn right. The turning procedure is to be carried out in an automated manner without intervention of the driver in order to provide a continuously autonomous driving experience.

A query is sent to a central server from the vehicle 100. In the response, for the current driving relationship (i.e. for the current lane 251), the ID of the relevant traffic signal 201 and/or the precise position of the traffic signal 201, as well as a confidence value 252 are supplied. If a relatively high confidence value 252 exists, the traffic signal 201 indicated by the server can be selected, and the automated driving function can accelerate and brake in an automated manner for the phases of the traffic signal 201. The situation can thus be navigated in an automated manner safely and comfortably.

In the case of a relatively low confidence, an automated lane change to an adjacent, better suitable lane 251 can be prompted, or a manual selection of the relevant traffic signal 201 can be enabled before a change is made to the manual driving mode. During the manual selection, the possibility can be given to the driver by means of an operating element, for example a touchscreen, to select the currently valid traffic signal 201.

While driving over the intersection, data from individual vehicles 100 can be sent to the server. The levels of confidence can be further improved or updated by means of a learning method for each driving relationship or lane 251 and traffic signal 201.

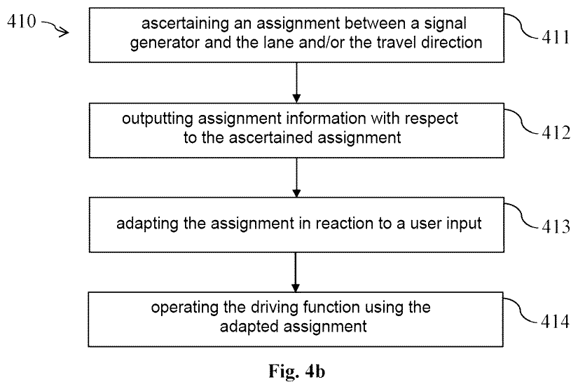

FIG. 4a shows a flow chart of an exemplary (possibly computer-implemented) method 400 for operating a driving function for automated longitudinal and/or lateral guidance of a vehicle 100 on a (multilane) approach roadway 250 to a signaling unit 200 (in particular to a traffic signal system). The signaling unit 200 can comprise multiple different signal generators 201.

The method 400 comprises ascertaining 401 a first assignment of a signal generator 201 of the signaling unit 200 to a first lane 251 of the approach roadway 250 traveled by the vehicle 100. The first lane 251 can be associated with a specific travel direction of the vehicle 100 at the signaling unit 200 (for example, turning to the left, driving straight ahead, or turning to the right). The first assignment can be ascertained on the basis of a digital map for the roadway network traveled by the vehicle 100 and/or on the basis of the sensor data of one or more surroundings sensors 103 of the vehicle 100.

The method 400 furthermore comprises ascertaining 402 a first confidence value 252 for the confidence of the first assignment. The confidence for an assignment can indicate (or correspond to), for example, the probability that the assignment is correct. The first confidence value can be ascertained on the basis of the digital map, wherein the digital map can indicate a confidence value for each of different possible assignments between lanes 251 and signal generators 201.

Furthermore, the method 400 comprises prompting 403, depending on the first confidence value 252, a lane change of the vehicle 100 to an adjacent second lane 251 of the approach roadway 250 (wherein the second lane 251 is associated with the same travel direction as the first lane 251).

FIG. 4b shows a flow chart of a (possibly computer-implemented) method 410 for operating a driving function for automated longitudinal and/or lateral guidance of a (motor) vehicle 100 on an approach roadway 250 to a signaling unit 200. The measures described in this document are each applicable individually and in combination to both methods 400, 410.

The method 410 comprises ascertaining 411 an assignment of a signal generator 201 of the signaling unit 200 to the lane 251 of the approach roadway 250 traveled by the vehicle 100 and/or to the planned travel direction 264 of the vehicle 100 at the signaling unit 200 (for example, on the basis of the digital map and/or on the basis of the sensor data of the one or more surroundings sensors 103).

The method 410 furthermore comprises outputting 412 assignment information with respect to the ascertained assignment to the driver of the vehicle 100 (for example, on a display screen of the vehicle 100).

Furthermore, the method 410 comprises adapting 413 the assignment in reaction to a user input, and operating 414 the driving function depending on the adapted assignment.

The comfort, the safety, and/or the reliability of a driving function can be increased by the measures described in this document.

The present invention is not restricted to the exemplary embodiments shown. In particular, it is to be noted that the description and the figures are only supposed to illustrate the principle of the proposed methods, devices, and systems.

1.-15. (canceled)

16. A device for operating a driving function for at least one of automated longitudinal or lateral guidance of a vehicle on an approach roadway to a signaling unit, the device configured to:
ascertain a first assignment of a signal generator of the signaling unit to a first lane of the approach roadway traveled by the vehicle;
ascertain a first confidence value for a confidence of the first assignment; and
prompt a lane change of the vehicle to an adjacent second lane of the approach roadway depending on the first confidence value.

17. The device according to claim 16, wherein the device is further configured to:
ascertain a second assignment of a signal generator of the signaling unit to the adjacent second lane of the approach roadway;
ascertain a second confidence value for a confidence of the second assignment;
compare the first confidence value with the second confidence value; and
depending on the comparison, prompt a lane change of the vehicle to the second lane of the approach roadway.

18. The device according to claim 16, wherein the device is configured to at least one of:
prompt the lane change of the vehicle to the second lane when it is ascertained in the context of the comparison of the confidence values that the confidence of the second assignment is higher than the confidence of the first assignment; or
not prompt the lane change of the vehicle to the second lane when it is ascertained in the context of the comparison of the confidence values that the confidence of the first assignment is higher than the confidence of the second assignment.

19. The device according to claim 16, wherein the device is configured to:
ascertain a planned travel direction of the vehicle at the signaling unit, on the basis of at least one of a driving route planned in a navigation system for the vehicle or on the basis of a travel direction associated with the first lane;
on the basis of a digital map for a roadway network traveled by the vehicle, ascertain a set of lanes of the approach roadway for the planned travel direction of the vehicle at the signaling unit, wherein the set of lanes comprises the first lane; and
select the second lane from the ascertained set of lanes.

20. The device according to claim 16, wherein the device is configured to:
prompt an automated lane change of the vehicle to the second lane of the approach roadway depending on the first confidence value; or
prompt a driver of the vehicle by outputting a notification to carry out the lane change of the vehicle to the second lane of the approach roadway manually depending on the first confidence value.

21. The device according to claim 16, wherein the device is configured to:
on the basis of sensor data of one or more surroundings sensors of the vehicle, ascertain a signaling status of the signal generator of the signaling unit, which is assigned to the lane traveled by the vehicle; and
operate the driving function for at least one of automated longitudinal or lateral guidance depending on the ascertained signaling status.

22. The device according to claim 16, wherein:
the device is configured to ascertain the first confidence value for the confidence of the first assignment on the basis of a digital map for a roadway network traveled by the vehicle; and
the digital map for each of different lanes of the approach roadway indicates an assignment of at least one signal generator of the signaling unit to the respective lane and a confidence value for the respective assignment.

23. The device according to claim 16, wherein the device is configured to:
output assignment information with respect to the first assignment to a driver of the vehicle when the first confidence value indicates that the confidence of the first assignment is less than a confidence threshold value; and
adapt the first assignment in reaction to a user input.

24. A device for operating a driving function for at least one of automated longitudinal or lateral guidance of a vehicle on an approach roadway to a signaling unit (200), the device configured to:
ascertain an assignment of a signal generator of the signaling unit to at least one of a lane of the approach roadway traveled by the vehicle or a planned travel direction of the vehicle at the signaling unit;
output assignment information with respect to the ascertained assignment to a driver of the vehicle;
adapt the assignment in reaction to a user input; and
operate the driving function depending on the adapted assignment.

25. The device according to claim 24, wherein the device is configured to:
ascertain a confidence value for a confidence of the assignment; and
output the assignment information with respect to the ascertained assignment to the driver of the vehicle when the confidence value indicates that the confidence of the assignment is less than a confidence threshold value; and/or
suppress the output of the assignment information when the confidence value indicates that the confidence of the assignment is greater than the confidence threshold value.

26. The device according to claim 25, wherein the device is configured to at least one of:
abort the operation of the driving function;
prompt a transfer to the driver of the vehicle when no user input for adapting; or
confirm the assignment is detected in reaction to the output of the assignment information within a predefined period of time.

27. The device according to claim 24, wherein the device is configured to:
acquire a user input;
determine whether the assignment indicated by the assignment information is confirmed or adapted by the user input;
operate the driving function depending on the assignment indicated by the assignment information if it is confirmed by the user input; and
operate the driving function depending on the adapted assignment if the assignment indicated by the assignment information is adapted by the user input.

28. The device according to claim 24, wherein the device is configured to:
output a visual representation, which displays multiple different signal generators of the signaling unit, which can be assigned to at least one of the lane of the approach roadway traveled by the vehicle or the planned travel direction of the vehicle at the signaling unit, wherein the signal generator from the ascertained assignment is visually highlighted in the visual representation;
ascertain a user input with respect to a selection of one of the displayed signal generators by the driver; and
adapt the assignment based on the selected signal generator.

29. A method for operating a driving function for at least one of automated longitudinal or lateral guidance of a vehicle on an approach roadway to a signaling unit, wherein the method comprises:
ascertaining a first assignment of a signal generator of the signaling unit to a first lane of the approach roadway traveled by the vehicle;
ascertaining a first confidence value for a confidence of the first assignment; and
prompting, depending on the first confidence value, a lane change of the vehicle to an adjacent second lane of the approach roadway.

30. A method for operating a driving function for at least one of automated longitudinal or lateral guidance of a vehicle on an approach roadway to a signaling unit, the method comprising:
ascertaining an assignment of a signal generator of the signaling unit to at least one of a lane of the approach roadway traveled by the vehicle or a planned travel direction of the vehicle at the signaling unit;
outputting assignment information with respect to the ascertained assignment to a driver of the vehicle;
adapting the assignment in reaction to a user input; and
operating the driving function depending on the adapted assignment.
